(19) United States
(12) Patent Application Publication
(10) Pub. No.: US 2023/0417624 A1
(43) Pub. Date: Dec. 28, 2023

(54) Apparatus and Method For Monitoring Railroad Track For Buckling Risk

(71) Applicant: Frank J. Smith, Long Beach Townshiip, NJ (US)

(72) Inventor: Frank J. Smith, Long Beach Townshiip, NJ (US)

(21) Appl. No.: 18/211,266

(22) Filed: Jun. 18, 2023

Related U.S. Application Data
(60) Provisional application No. 63/355,607, filed on Jun. 25, 2022.

(51) Int. Cl. G01M 5/00

(52) U.S. Cl. CPC G01M 5/0041; G01M 5/0025; G01M 5/0091

(57) ABSTRACT

A method of observing strain conditions in steel rails used by the railroad industry, to warn of risk of thermally induced rail buckling at elevated temperature or thermally induced fracture of rail joints at low temperature. The method permits observation of changes in the rail strain along the length of the rail and changes in the pattern of the strain over distance, time and temperature. The observation over distance is accomplished by means of a fiber optic cable having spaced backscatter producing discontinuities, bonded to the side of the rail. The cable is interrogated by an electro-optical system which provides a profile of the changes in strain along the length of the rail. The strain changes and corresponding rail temperatures are digitally recorded. The local change in rail strain is observed as a change in spacing between fiber discontinuities. The analytical portion of the electronic package compares local changes in rail temperature to local changes in rail strain, and generates a warning when the strain drops below a minimum predicted amount which is a function of temperature, such drop being a predictor of imminent track buckling at high temperature or imminent rail joint fracture at low temperature.

### CROSS-REFERENCE TO RELATED APPLICATION

This application claims the benefit of U.S. Provisional Application Ser. No. 63/355,607 filed Jun. 25, 2022 and entitled Method For Monitoring Railroad Track For Buckling Risk, and Fiber Optic Cable For Same.

### BACKGROUND OF THE INVENTION

This invention relates to early detection of conditions leading to railroad track buckling, a phenomenon that has plagued the railroad industry since it switched to continuous welded rail (CWR). Such rail, which is typically in sections one-quarter mile long, frequently cannot expand longitudinally with temperature increase, by a sufficient amount to avoid buildup of internal stress, the expansion being restricted due to friction with the rail substrate, and various related constraints.

As rail temperature increases, the resulting extremely high thermally induced compression pressure causes the rail to “buckle”, assuming an “S” shape (typically horizontally oriented) to accommodate the thermally induced increase in length. The transition tends to occur relatively suddenly, and frequently when a railroad car is on the rail in the region of maximum longitudinal stress.

The phenomenon of track buckling and associated concepts are discussed in a 2013 publication of the U.S. Department of Transportation, Federal Railroad Administration, entitled “Track Buckling Prevention: Theory, Safety Concepts, and Applications”, Document No. DOT/FRA/ORD-13/16.

Since buckling is a common cause of derailment, it is vital to develop a system which can provide early detection of buckling risk and locate the part of the track where the risk is greatest.

The use of strain sensitive fiber optic cable to monitor strain changes in a rail has been proposed. See this inventor's U.S. Pat. No. 10,907,958 entitled Railroad Track Defect Detection Apparatus and Method. However, no method or system for early detection of buckling has been disclosed.

Accordingly, there is need for an arrangement to generate a warning when the risk of track buckling is high, and to determine the part of the track where that buckling is most likely to occur.

### Overview of the Invention

The rail technique described herein advances over existing arrangements by providing continuous monitoring of rail strain as opposed to current practices that provide a series of discrete strain measurements.

The invention disclosed herein provides a warning to train operating personnel that a portion of the track is in danger of buckling, and the location of where the risk of buckling is high. This is done by providing a warning that a section of rail is exhibiting strain conditions that commonly precede track buckling, and the location of the affected portion of the track. This warning permits maintenance work to reduce the internal stress of the rail at the affected location, and thus avoid possible derailment.

### Stress and Strain

Stress is force on a material, per unit area. It may be measured, for example, in pounds per square inch or newtons per square meter.

Strain is change in dimension of a solid, per unit length, width or height, due to application of force to the solid. It is dimensionless and may be specified in inches per inch or meters per meter, for example.

### Longitudinal Stress and Strain

Stress is pressure to which a member is subjected, namely applied force divided by the cross section of the solid transverse to the direction of the force. When a rail is under stress, it deforms; our interest here being longitudinal deformation, that is, deformation due to thermal expansion and contraction of the rail, that would change its length in the absence of restraint due to friction and/or other mechanical constraints.

In the case of a continuously welded rail, a compressive force is internally applied by temperature increase. This force causes the rail to increase in length. When the rail is restrained so that it cannot increase in length in a straight line, it will increase in length by buckling. While the other two dimensions of the rail are also increased by thermal expansion, that is not of interest here.

Rails are made of steel which typically has a coefficient of linear expansion of 11.5×10⁻⁶ per degree Celsius. For a one-quarter mile length of CWR, a 68° F. temperature increase would result in the rail length increasing by about 3.6 inches.

The principal object of the invention is to detect the strain conditions present in a rail that give rise to buckling. This phenomenon is a hazard to safe railroad operation because a buckled track has the potential to derail a train.

A track is said to buckle when an otherwise straight section or a gradual curved section spontaneously twists into an “S” shape. The rails, sometimes with the ties and sometimes broken away from the ties, bend into tight curves that are difficult for a train to navigate without toppling.

Buckling is a way for a rail to release excess internal energy. In prior rail assembly, tracks were bolted together, and buckling did not happen. Each rail section was 39 to 55 feet long and had a one-quarter inch gap between sections. Seasonal expansion and contraction were accommodated by each gap, which opened in the winter and closed in the summer. In recent times, however, the industry has adopted CWR as a way of reducing maintenance by eliminating the need for constantly tightening the rail joint bolts, and as a way to improve motive efficiency.

Because CWR has eliminated the gaps, the tracks have to be designed and constructed with strict attention to the need to provide for rail expansion and contraction, with mixed results.

Considerable effort has been devoted to schemes for predicting where, when and under what conditions rail buckling is likely to occur. However, no reliable and accurate buckling prediction system currently exists.

A commonly used process is to install long sections of CWR under tension, preferably at moderate temperature. The rail sections are stretched before butt welding the ends. When the rail heats up in the summer, the rail tension will become rail compression. If this is done correctly, the rail compression will not exceed a safe stress (pressure) limit, even during the most severe environmental conditions.

However, this process, known as Neutral Temperature Installation, is based on the idealized assumption that the rail is evenly heated during temperature increases, and free to move longitudinally in order to evenly distribute the rail strain over the continuous rail section. Should something happen to alter these assumptions, there can be local stress concentrations that exceed safe limits.

Unexpected concentrations of rail stress are invisible to inspection. The buckling that results from these excessive stress conditions is violent and sudden. It may happen spontaneously or it may be triggered by a train passing the buckle prone track section. The track may buckle under a locomotive and derail the following car. Buckling may also be a hazard to track personnel who may trigger a buckling event by some rail maintenance process.

There is a considerable body of work relating to track buckling analysis and prediction. But there appears to be little work relating to the physical detection, in the field, of the stress or strain conditions prior to track buckling.

### Current State of the Art

Current methods for the remote measurement of strain in railroad rails involve the attachment of strain gauges to the rail surface. The gauges can be part of a fiber optic sensor cable or individually attached sensors. The most common fiber optic-based strain measuring method involves the use of Fiber Bragg Gradient (FBG) structures integral to the sensing fiber. These strain sensitive regions of the fiber, which locally alter its index of refraction, are located at regular intervals along the cable and are part of the structure of the fiber. This technology permits the measurement of local strain at discrete and regularly spaced intervals along the cable.

This technology has not been adopted by the industry, primarily because the distance over which it provides discrete measurements of strain is limited.

To observe strain that may indicate the onset of rail buckling, a strain sensor must cover long distances, from ½ to 5 miles. It must provide continuous information, not just at a limited number of discrete locations. The FBG technology of local strain sensing may fail to observe the locus of a strain concentration. The observation focus must include all of the rail within the field of observation.

A system to detect buckling does not require a calibrated measurement of strain. What is important is to observe the changes in strain over time and temperature.

FBG has at least three problems for railroad application. First, it is much too expensive to make it commercially attractive. Second, the required fiber interrogation equipment, which involves spectrum analysis, is very sophisticated in design and operation and thus poses maintenance and calibration challenges in the railroad wayside environment. Third, attachment of any optical fiber, especially an FBG fibber, to a steel rail for any length of time is a serious challenge. The fiber in the rail environment must survive severe changes in temperature, severe vibration, environmental challenges of wind, water, snow and dirt; and must avoid damage from human and automated maintenance machines.

Applicant's “smart rail” U.S. Pat. No. 10,907,958 issued in 2021 and entitled “Railroad Track Defect Detection Apparatus and Method” is directed to detection of deformation in a fiber optic cable, which may be due to mislocation of the associated rail(s). However, the optical fiber described in this patent only detects bending of the fiber due to rail mislocation caused by stress applied to the rail by cars and locomotives. It is sensitive to transverse strains, and does not detect longitudinal strains.

### SUMMARY

As herein described, apparatus is provided for monitoring longitudinal strain in a railroad rail and determining a location along the rail where there is a significant risk of buckling. The apparatus includes a length of fiber optic cable secured to a side of the rail. The cable including a series of longitudinally spaced optical backscatter creating discontinuities. An optical signal transmitting, receiving and data processing system is associated with the cable to determine changes in the cable strain between the discontinuities. A threshold setting system sets a rail temperature dependent threshold strain change parameter, which parameter corresponds to a minimum acceptable level of longitudinal rail strain change between the discontinuities.

A warning system is coupled to the optical signal transmitting, receiving and data processing system and the threshold setting system to generate a buckling risk warning signal when the cable strain change at a buckling risk location adjacent one or more of the discontinuities falls below the parameter set by the threshold setting system. A buckling risk location system associated with the warning system determines and displays the buckling risk location.

### IN THE DRAWING

FIG. 1 is a diagram showing the overall arrangement of the invention.

FIG. 2 is a diagram showing the arrangement whereby a strain sensitive fiber optic cable is attached to a rail.

FIG. 3A shows lateral detail of the strain sensitive optical fiber of the invention and its attachment to a rail.

FIG. 3B is an end view of a rail showing sources of restraining forces that oppose thermal elongation of a rail.

FIG. 4 is a side view of a rail according to the invention, illustrating how the cable strain profile is affected by track conditions. This figure illustrates the manner in which the invention monitors changes in rail strain to look for a region of low strain at elevated temperature, which corresponds to a location at high risk of track buckling.

FIG. 5 corresponds to FIG. 4, where the region at high risk of track buckling has a different location than as shown in FIG. 4.

FIG. 6 corresponds to FIGS. 4 and 5, where all track regions exhibit the same strain change, which change is above a preset minimum acceptable value, so there is no region at risk of buckling.

FIG. 7 is an illustration showing the fiber optic cable of the invention and the relationship between rail temperature and rail strain.

FIG. 8 is a functional block diagram showing the apparatus of the invention.

FIG. 9 is a conceptual lateral view illustrating the application of an alternate embodiment of the invention to a flexible structural element such as a suspension bridge support cable.

FIG. 10 is a conceptual view of the structural element of FIG. 9, illustrating the response of the same to structural integrity degradation.

### DETAILED DESCRIPTION

The apparatus and method described herein is based on the observation that buckling occurs when elevated temperature causes unusually high stress in a region where the rail is not free to elongate, because of friction with the track bed and possibly other constraints. In the case of elevated temperature, by monitoring strain increase as a function of distance along the rail, a region of unacceptably low increase is a place where there is a high risk of buckling.

The invention is also applicable to the detection of excessive stress/strain due to cooling. At sufficiently low temperatures, longitudinal stress due to contraction of the rail can cause welded joints between rails to fracture.

In the case of elevated temperature, the system described here (i) monitors increases in strain as a function of location along the rail, (ii) determines what the minimum increase in strain should be for rail at its local temperature, and (iii) generates a warning when the observed increase in strain (if there is any) is substantially less than the amount predicted for a freely expanding rail at the actual local rail temperature.

The system and method described above can also detect conditions of rail contraction at low temperature, that could predict the breaking of rail welds; by locating regions of the rail that contract less than predicted at corresponding low temperatures.

The arrangement described herein can be used over a length of rail extending over a distance of five miles or more. It will repeatedly observe changes in rail longitudinal strain at any location within the observed range. The arrangement can be used continuously for the life of the rail segment.

This arrangement can be applied to observe changes in rail strain without structurally or physically modifying the rail. It can be used on new and existing rails. It can be used on all weights and configurations of rails used in the railroad industry.

The backscatter creating optical fiber and associated system described herein can be used to observe local expansion as well as contraction of a length of a rail or other elongated member, such as a steel beam or support cable, over a distance. When a light source sends a pulsed laser beam through the fiber, each discontinuity reflects a relatively small percentage of the light energy back toward the source.

This reflected or “backscattered” energy is in the form of a jagged looking “pulse” which is received at or near the light source and can be processed to yield information about the distance between the corresponding discontinuity and the light source or receiver. The discontinuities preferably are equally spaced along the fiber, with each discontinuity preferably having a length along the fiber of 20 to 50 centimeters.

When multiple backscatter creating discontinuities are present in the fiber, as in the present invention, the light reflected back toward the laser light source comprises a series of such pulses which are spaced apart in time by intervals corresponding to the distance between discontinuities. These pulses are processed to determine and evaluate changes in said time intervals, which correspond to changes in longitudinal strain within the rail, support cable or member. Thus, each pulse transmitted by the laser light source results in a series of reflected or backscattered pulses.

When the light source repetitively transmits suitably spaced (in time) “interrogating” pulses, the aforementioned observation results in a repetitively generated profile of the strain change of the observed material as a function of distance. The distance is derived from the round trip transit time of an optical signal between each region of cable backscatter and a monitoring station. This arrangement has the advantage over existing systems of providing for continuous monitoring of the member or cable for structural changes of interest. It is less expensive and more versatile than currently existing Fiber Bragg Grating (FBG) systems.

The optical fiber used in the present arrangement is conventional fiber which is modified to introduce discontinuities that provide the required backscatter, while locally attenuating the amplitude of the optical signal which passes through the discontinuity by a small amount, preferably by no more than 5% per discontinuity.

The discontinuities preferably are equally spaced along the fiber. They are “interrogated” by the aforementioned laser which repetitively sends a pulsed light beam through the fiber; causing the discontinuities to reflect jagged looking light “pulses” back toward the light source. Since the initial spacial interval between backscatter pulses is known, autocorrelation techniques can be used to strengthen the initial received signal. The distance between adjacent discontinuities is preferably in the range of thirty to one hundred feet.

The initial received signal, i.e., the signal when all parts of the cable are subjected to no strain or equal strain, will appear as a series of negative spikes which are equally spaced in time.

As the rail temperature rises and the rail and fiber expand, the time interval between negative spikes increases. If a region of the rail is unable to thermally expand fully (or at all), due to friction and/or other constraint, the time interval between spikes increases unevenly, with the region associated with the smallest time interval being that of maximum thermally induced stress, and thus being the region most likely to buckle.

In the aforementioned U.S. Pat. No. 10,907,958, bending of the optical fiber due to local changes in the rail produced backscatter which was indicative of rail deformation due, for example, to one rail section shifting horizontally with respect to an adjacent rail section. That arrangement did not respond to longitudinal strain, i.e., strain or movement along the length of the fiber.

The fiber design utilized in the present system allows sensing of movement of fiber discontinuities along the vector parallel to the length of the fiber and thus the length of the rail to which the fiber is secured—the longitudinal direction. Changes in spacing between fiber discontinuities correlate to changes in rail strain. Since the fiber is adherent to the side of the rail, there is a one-to-one correlation between rail strain change and fiber strain change.

The fiber optic sensing method previously known was to use Optical Time Domain Reflectometry (OTDR) to detect micro changes in the structural alignment of the fiber. Local bending (micro bending) of the fiber indicated the action of external mechanical forces on the fiber. The OTDR technology provided a means to detect these micro bends in the fiber and provide the location of the mechanical influence on the fiber. This method required a fiber sensitive to bending, transverse action, not longitudinal changes.

In order to observe longitudinal movement of a rail when heated or cooled, the fiber needs to be sensitive to changes in fiber length.

The linear dimensional change to be observed as herein described is repeated observation of the changes in rail length between relatively small regions (on the order of 30 to 100 feet in length) of the rail. This requires observing the changes in local expansion and contraction over the total observed length, which may typically be about five miles.

The strain change sensor used to monitor rail sections must observe local variations in the expansion/contraction profile of the rail. Each local variation in strain represents a fraction of the total variation in length of the observed section of rail. Each of these local variations may or may not be consistent with the overall variation. In some regions the local incremental (percentage) change may be in excess of the overall changes in length.

In some local areas of the rail there may be no observable thermally induced change in length, due to restraining forces acting on the rail and sensor cable. These areas of no, or very little, change in strain, when they occur where there is an elevated rail temperature, are the areas where buckling is likely.

In order to observe local changes in strain over the continuous length of the sensor cable, the optical fiber herein described includes regularly spaced markers, sometimes referred to herein as backscatter creating discontinuities. These markers, which reflect pulses back toward the source of an optical signal traversing the cable, are detectable by existing OTDR technology.

The OTDR will detect and measure the distance from the instrument to each marker. These instrument to marker distances can be converted to the distances between adjacent markers. The OTDR can, if desired, also be set to directly measure the distances between adjacent markers.

An increase in the length of the rail, with the sensor fiber bonded to it, will result in a proportionate increase in all, or nearly all, of the local marker to marker distances. If the rail expands uniformly over its length, the local changes in distance between markers will be equal. If for some reason, the rail does not expand uniformly, the local changes in length will reflect that non-uniform change in length. In areas where the local expansion is less than that expected due to local rail heating, local rail stress may be building up.

The absence of observed local strain increase (movement) in a section of rail that is at an elevated temperature is indicative of a local increase of rail stress (force), which is a predicate for track buckling. The absence of strain increase with temperature increase can be a warning of a buckling threat.

To observe changes in length of a rail continuously along the length of the fiber optic sensor cable secured thereto, the fiber contains optically detectable markers at regular intervals. The markers may be minute changes in the optical density of the fiber or some other alteration to the fiber structure. These minute changes to the optical fibers structure cause local backscatter; reflecting light pulses back toward the light source, while only slightly reducing the amplitude of an optical signal transmitted through the fiber. OTDR technology is specifically designed to detect the presence of such markers and determine their location.

The markers are built into the fiber structure during the manufacturing process by, for example, alter the density of the core material in longitudinally narrow regions at controlled intervals during the fiber manufacturing process. The altered density, or similar modification, causes an increase of local backscatter that is detectable by OTDR equipment.

Optical fibers can be manufactured with differing marker spacing to suit specific rail monitoring applications. Smaller spacing of the markers improves the resolution of the strain profile at the expense of having to process more data. For a given number of markers per sensor fiber, the distance between markers can be increased at the expense of strain resolution.

The process of embedding markers into the fiber may be a variation of an existing manufacturing process associated with Fiber Bragg Gradient (FBG) cable. In the manufacture of FBG strain sensor cable, the fiber is altered at regular intervals by the insertion of an optical gradient, thus locally changing its index of refraction. Each gradient consists of multiple precisely spaced changes in fiber density. In the present arrangement, which senses amplitude, not phase or frequency, fiber markers need not be so complex. A single node of fiber density change of sufficient magnitude will suffice. FBG fiber technology is described extensively in available industry documents.

The main difference between FBG technology and the present invention is in the use made of the changes to the fiber. FBG technology allows a series of discrete strain measurements along the length of the sensor cable. In the present invention strain information is not generated by the filtering effect of the gradient, but rather, it is the position of the fiber marker at a determinable distance from the OTDR device. In the application of an FBG sensor cable, each gradient must be bonded to the material being observed at the location of the FBG sensor, since it acts as a string of individual strain sensors. The fiber between FBG sensors need not be bonded to the material being measured. In the present invention, however, the entire fiber is part of the sensor system and must be bonded to the rail.

The design of the optical fiber longitudinal strain sensing cable using embedded markers requires a series of tradeoffs of distance, resolution, and processing speed. The tradeoff is unique to each application and the linear sensor concept is adaptable to all situations. The following will consider the railroad application. The rationale for applying longitudinal strain sensing to a rail is to observe potential track buckling conditions in real time. While there is no firm definition of the scale of track distortion that is classified as buckling, it is understood to be a degree of distortion of track geometry that will likely cause a train to be derailed.

Based on industry research, a buckled track has in general, a sideways displacement of greater than six inches within a length of thirty feet. The rail distortion can appear in a wide variety of forms. For the example that follows, thirty longitudinal feet will be used as the needed resolution. To assure that a thirty-foot deviation from acceptable strain change can be detected, the markers will need to be spaced every ten feet; which places at least one and possibly two marker spaces in the buckling zone.

The exact location of the buckled region of track can be expected to occur within several miles of known track hardware such as switches and bridge abutments. A practical buckling sensor cable therefore must span several miles of rail. Contemporary OTDR equipment commonly claims an operating range of 10,000+ feet. A single wayside package can support sensor cables extending in both directions along the track. This arrangement would conservatively provide range of about four miles of track. One wayside package would support four sensor cables (two rails in two directions).

One marker every ten feet will provide about 1,000 markers on the sensor cable. That will result in a data base containing about 1,000 measurements of marker to marker spacing. Each marker reflects a small amount of optical energy back to the OTDR as backscatter. The more energy each marker reflects back, the less energy the optical pulse has to illuminate markers further from the OTDR. The total number of markers on a sensor fiber will be limited by the sensitivity of the OTDR to detect the markers and the available pulse power used to illuminate the markers. One thousand markers per sensor cable appears to be consistent with the capabilities of contemporary compact and portable OTDR devices.

Among the challenges in the design trade-off described above is the interplay of available optical pulse power, backscatter receiver sensitivity, and the total number of detectable markers. The railroad application provides a valuable benefit in this trade-off, namely time.

In the communications cable application environment, the OTDR optical interrogation of the cable occurs in microseconds. Processing of the data is carried out in milliseconds. In the railroad world of track buckling, such rapid action is not necessary. The wayside package is permanently attached to the rails and sensor cables. Strain changes are caused by ambient heating of the rails, which takes place over many hours. There is ample time to make as many repeated distance measurements as may be needed, with very little change in the environment during the period of observation.

The wayside package includes memory functions that allow the summation of repeated observations of the distance between each marker. The accumulation of repeated measurements can be acted on by auto-correlation algorithms to produce a data set with ever increasing accuracy and resolution. After each auto-correlation procedure, the data set can be tested for the presence of thermal stress indicated by a lack of rail strain.

The manufacturing process that embeds distance markers into the fiber can also embed other useful information. In one embodiment, a set of closely spaced markers (similar to a bar code arrangement) can be used to uniquely identify an individual sensor cable, that is, an individual optical fiber or strand. This is useful when multiple sensor cables or strands are associated with a single interrogator, and/or when a multi-strand cable has to be spliced; so that it is necessary to verify the accuracy and completeness of the splice. This information may consist of a binary code or similar configuration of information. Non-variable information embedded in the individual sensor fiber may be incorporated in the data set that represents the strain profile of the rail.

The information-conveying markers must be designed to be visible to OTDR technology and located such that there is no ambiguity between the distance markers and the data markers. This can be done by spacing groups of data markers close together compared to the spacing between distance markers, so that the data markers cause a distinctive backscatter pattern.

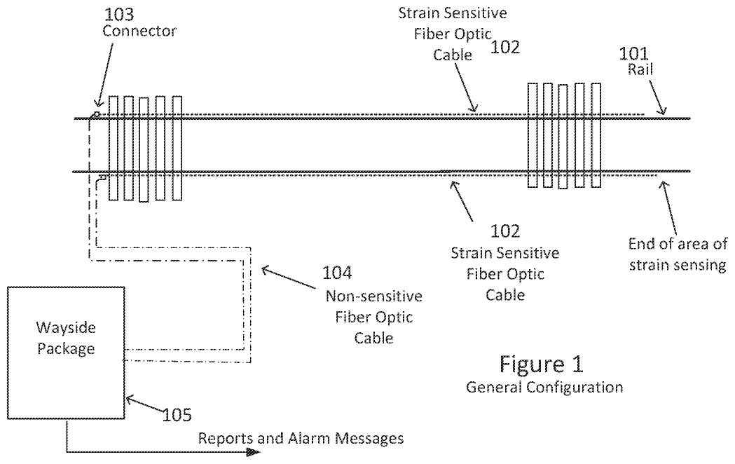

Referring to the drawings, FIG. 1 provides a general representation of the main physical components of the invention. It shows the fiber optic strain sensing cables 102 attached to the web (main part of the side) of two parallel rails respectively. The preferred cable orientation is on the web surface which is on the outside of the rail. The strain sensing cables are connected to the interrogator located in a wayside package 105 near the rails. The connecting fiber optic cables 104 have no environmental sensitivity; that is, they do not contain uniformly spaced markers. The interrogator, located in the wayside package 105, includes necessary electro-optical and digital components to perform the specified functions. The interrogator communicates actionable information concerning impending rail buckling conditions to the train dispatcher, to warn the dispatcher of an impending rail buckling condition.

The wayside package 105 includes a fiber optic interrogator consisting of: (i) a pulse laser light source, (ii) an optical backscatter detector, (iii) a computer-based timing system to detect the time-of-flight (round trip transit time) between the light source and each marker along the fiber, (iv) computer-based analytical software to compute differential time-of-flight (difference in transit times between the markers and the light source), (v) a fiber optic based distributed linear temperature measuring system to measure and record rail temperatures at appropriate intervals along the rail, (vi) a computer-based digital memory to retain the time-of-flight data and temperature data for both current and past observations, (vii) a computer-based software algorithm that converts current time-of-flight and temperature data into a rail profile of the relationship of temperature and differential time-of-flight, and (viii) a computer-based algorithm that identifies deviations in the relationship of the differential time-of-flight and rail temperature.

### DETAILED DESCRIPTION OF THE DRAWING

### FIG. 1

This figure provides a general representation of the main physical components of the invention. It shows the fiber optic strain sensing cables attached to both rails. The preferred orientation is to be on the web and on the outside of the rail. The strain sensing cable is connected to the interrogator located near the rails. The connecting fiber optic cable has no environmental sensitivity. The interrogator, located in a suitable wayside enclosure, includes necessary electro-optical and digital components to perform the specified functions. The Interrogator communicates actionable information concerning impending rail buckling conditions to the train dispatcher.

The wayside equipment includes a fiber interrogator consisting of: a pulse laser light source, an optical backscatter detector, a timing system to detect the time-of-flight for each known location along the fiber, an analytical device to compute differential time-of-flight, a fiber optic based distributed linear temperature measuring system to detect and record rail temperatures continuously along the rail, a digital recording assembly to retain the time-of-flight data and temperature data for both current and past observations, an algorithm device that converts current time-of-flight and temperature data into a rail profile of the relationship of temperature and differential time-of-flight, a processor using an algorithm that identifies deviations in the relationship of the differential time-of-flight and rail temperature.

Elements of FIG. 1: element 101 is the rail that is subject to strain sensing; element 102 is the optical fiber with strain sensing properties that is bonded to the rail; element 103 is the fiber optic connector that joins the strain sensing cable to the non-strain sensing fiber cable; element 104 is the non-sensitive fiber cable that connects the sensitive cable to the wayside package; element 105 is the wayside package that includes the opto-electronics components needed to interrogate the sensitive cable, to manipulate the resulting data and to initiate messages relating to the rail strain/stress conditions that may predict rail/track buckling.

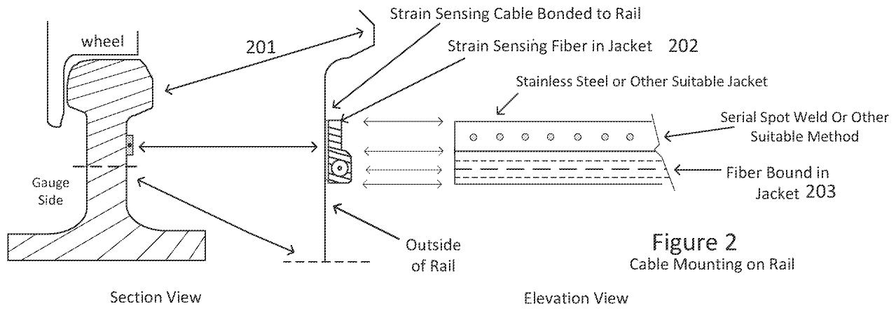

### FIG. 2

This figure represents a preferred method of bonding the strain sensing cable to the rail web. The sensing cable is attached in a manner that best transfers the expansion and contraction of the rail to the fiber. The preferred attachment method does not require any alteration to the rail structure. The drawing indicates that the sensitive fiber is to be protected from the railroad environment. The optimal bonding method provides long term, permanent, secure attachment.

Elements of FIG. 2: element 201 is the rail in elevation including the sensing cable; element 202 is the jacket that encloses the strain Sensing FO cable and is bonded to the rail; 203 is the Strain sensing fiber contained in the protective jacket that is bonded to the rail. The cable/jacket may serve to facilitate other related functions such as temperature measurements.

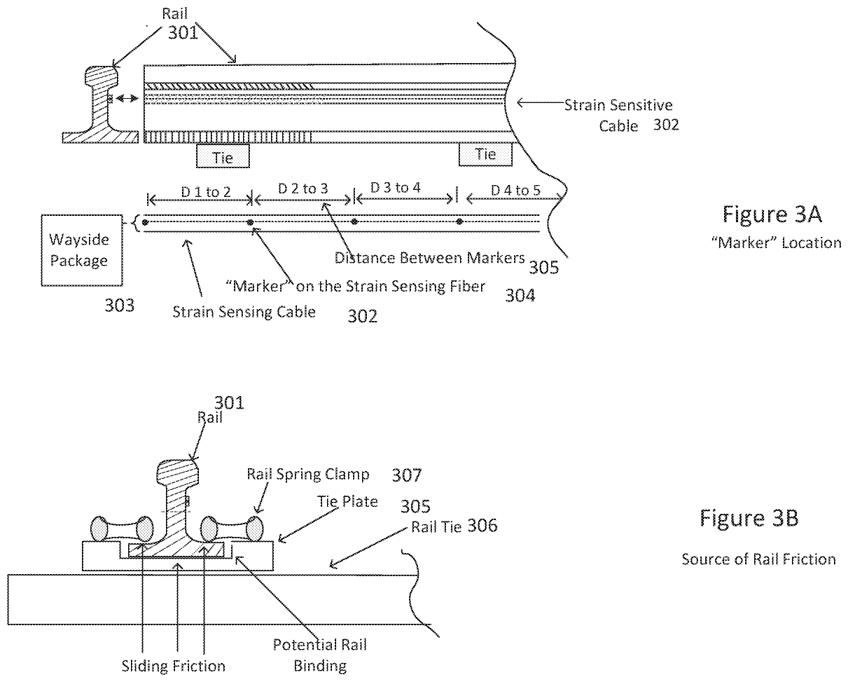

### FIGS. 3A and 3B

FIG. 3A illustrates the relationship between the rail and the “markers” incorporated into the sensor fiber. This drawing provides a graphic to illustrate the change of distances between markers and the relationship of those distance changes to the change in rail length. The term “marker” is to be understood to be a discontinuity feature of the optical fiber design that facilitates its detection by the interrogator that is part of the wayside package and permits measurement of the location of the discontinuity. These changes are detected by the interrogator that can be located at a distance from the rails. The preferred detection method is time-of-flight. This is commonly used in optical time domain reflectometry devices. The preferred technology includes detection of the light that is reflected from the marker/discontinuity in the direction of the interrogator.

Elements of FIG. 3A: element 301 is the rail to be observed; element 302 is the sensing fiber in the protective jacket; element 303 is the wayside package that includes the fiber interrogator and the associated electro-optical and data processing equipment.

FIG. 3B details the attachment of the rail to the tie plate and identifies the locations of rail to tie friction. The rail is restrained from longitudinal movement at each tie plate by friction between the rail and the tie plate, and between the retaining spring and the rail. The restraining force at each tie plate is cumulative. This cumulative restraint is greatest in the middle of an otherwise unrestrained rail. Ideally, each tie plate will contribute an equal restraining force on an expanding rail. A potential source of rail binding/blocking is the location where the edge of the rail foot contacts the side of the tie plate. Improper alignment of the tie plate and the rail foot can cause interference and excessive local restraint. The drawing is simplified by omitting the elastic pad that is sometimes used.

Elements of FIG. 3B are: element 301 is the rail; element 307 is the spring clip that holds the rail in place; element 305 is the tie plate that supports the rail and rests on the tie; element 306 is the tie/sleeper that supports the rails and rests on the ballast of the roadbed.

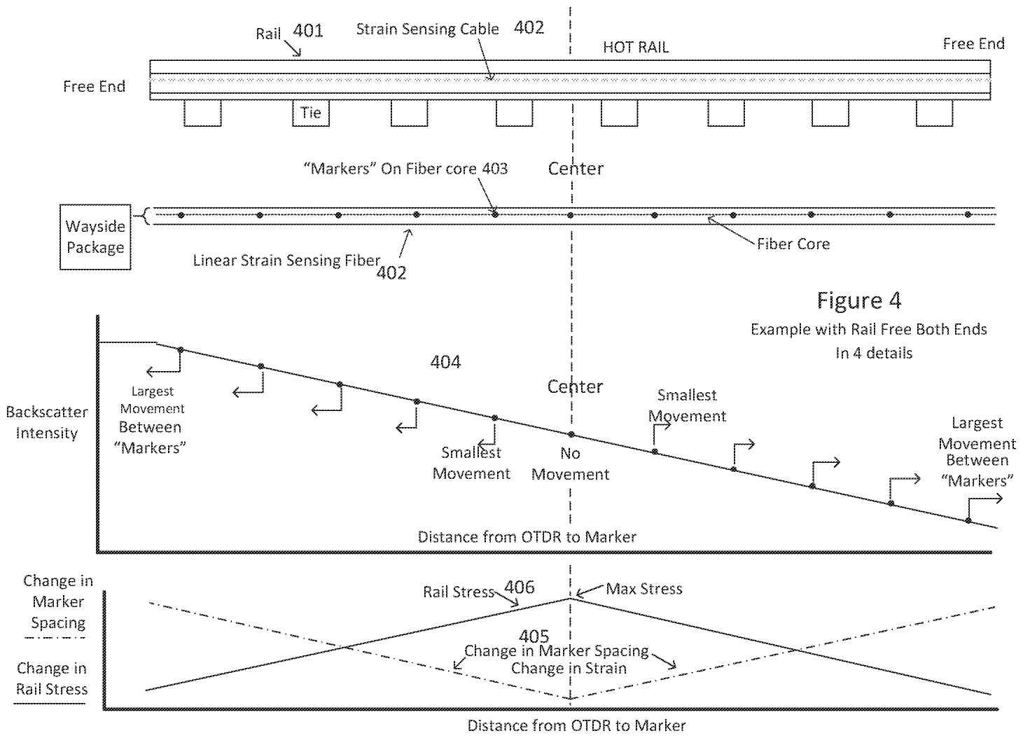

### FIGS. 4 to 6

These three figures illustrate the relationship between the movement of the fiber markers and the strain conditions exhibited in the rail. The three conditions illustrated are simplified and idealistic in order to more clearly illustrate the boundary conditions. All three figures assume that the rail is uniformly heated and resulting thermal stress (energy) is present. They all assume that the rail is restrained in the longitudinal direction by the cumulative effect of the friction between the rail and the tie plate below and the spring retainer clips above. It is assumed that the rail temperature is being observed in conjunction with the rail strain conditions. Rail temperature and strain/stress conditions may vary along the length of the rail. The conditions between any pair of markers may differ from the conditions between any other pair of markers.

FIG. 4 shows a hot rail, not restrained on the ends, but restrained by rail to tie plate friction. In this configuration the rail will expand in a manner dictated by the cumulative effects of each tie plate and clips. At the ends the restraining forces are minimum. In the center, the restraining forces, that is, the cumulative longitudinal forces on the rail, are maximal. The rail will expand least in the middle and most at the ends. The spacing of the fiber markers will change to mark this distribution of strain. If the restraining forces are uniform, the slope of the strain curve will be zero or near zero. Any lack of uniform restraining forces will be evident in the shape of the strain profile. The strain slope is a predictable function of rail temperature and cumulative restraining forces.

Elements of FIG. 4 are: element 401 is the rail to be observed for strain; element 402 is the longitudinal strain sensing cable bonded to the rail; element 403 is a representation of the markers that are incorporated into the design of the strain sensitive optical fiber and cable; element 404 is a representation of the marker distance from the start of the sensor cable as “seen” by the interrogator that is part of the wayside package; element 405 represents the changes in the spacing (change in distances) from marker to marker; and element 406 is a representation of the local rail stress.

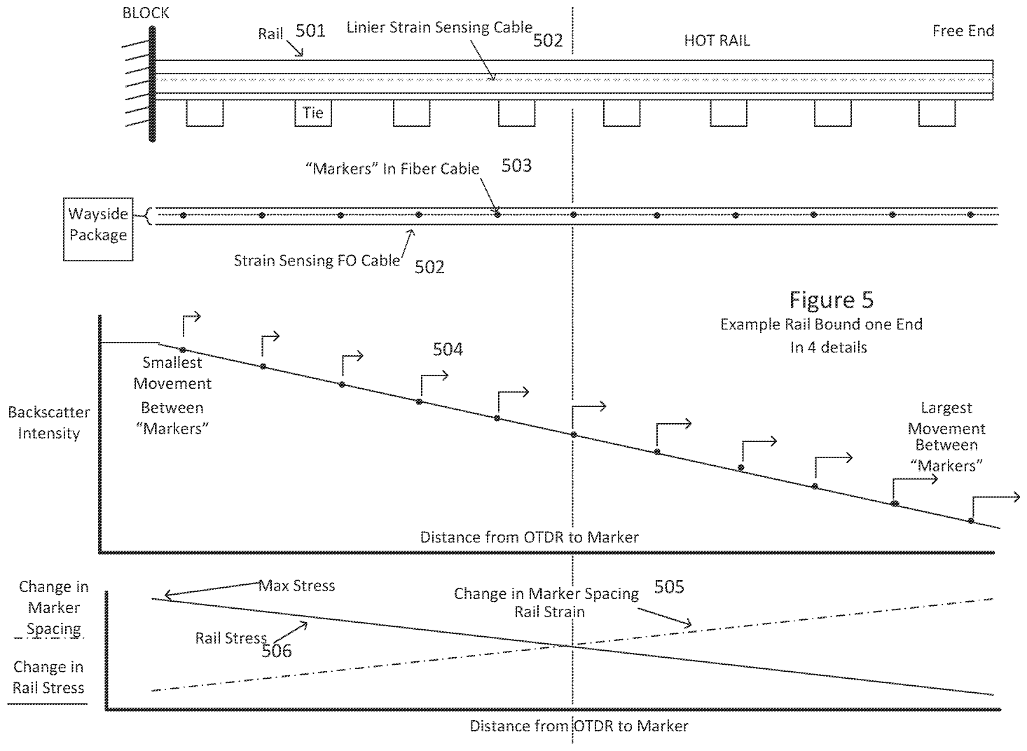

FIG. 5 shows a hot rail that is fixed on one end and restrained by rail to tie plate friction. In this configuration the rail cannot move against the blocked end. It can only expand in the direction of the free end. All of the cumulative longitudinal restraining forces will cause the greatest rail compression to occur at the end fixed against the block. The rail will expand the most at the free end and the least at the blocked end. The markers will illustrate the degree of rail expansion. The least change in the marker positions will occur next to the block. The greatest change in the positions of the markers will occur at the free end. The slope of the strain profile will reflect the change in the marker positions. The strain slope will be smooth (flat) from a minimum at the block to a maximum at the free end. If the restraining forces are uniform, the slope of the strain curve will be smooth. Any lack of uniform restraining forces will be evident in the shape of the strain profile. The strain slope is a predictable function of rail temperature and cumulative restraining forces.

Elements of FIG. 5 are: element 501 is the rail to be observed for strain; element 502 is the longitudinal strain sensing cable bonded to the rail; element 503 is a representation of the markers that are incorporated into the design of the strain sensing cable; element 504 is a representation of the marker distance from the start of the sensor cable as seen by the interrogator in the wayside package; element 505 represents the changes in the spacing (change in distances) from marker to marker; and element 506 is a representation of the local rail stress.

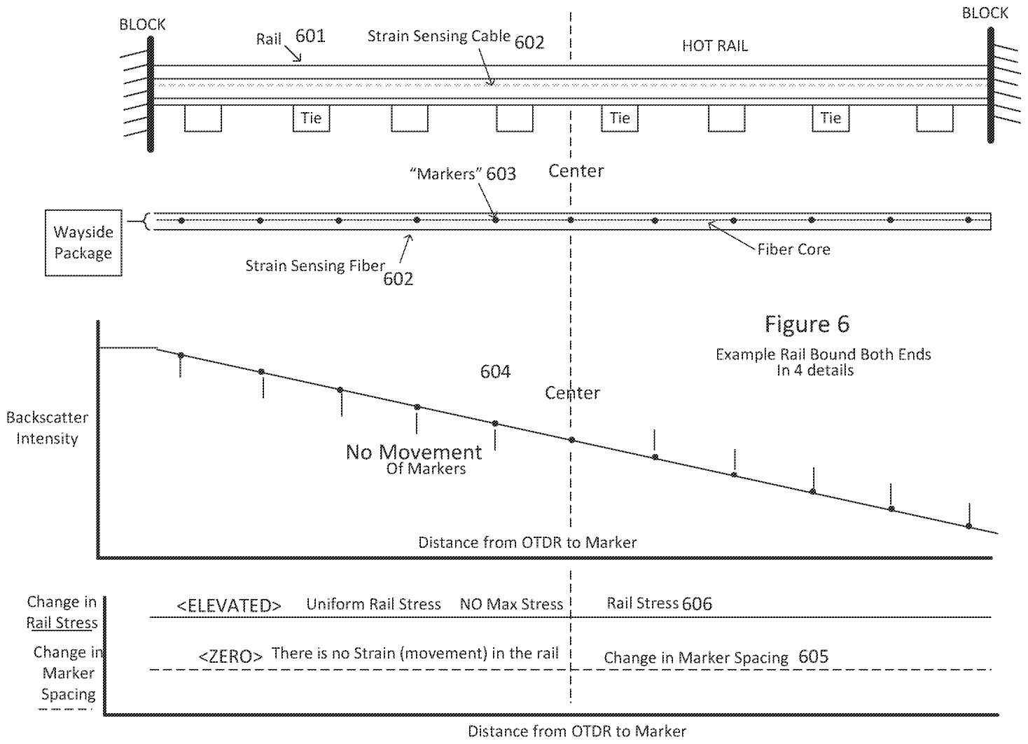

FIG. 6 shows a hot rail fixed on both ends where no rail expansion is permitted. In this configuration the rail is prevented from moving at both ends. It cannot expand with increasing temperature. The lack of rail expansion is observable in the lack of change in the position of the markers. When the rail is at an elevated temperature and there is no expansion in the rail, there is an accumulation of thermal stress (energy) that is indicative of impending rail buckling.

Elements of FIG. 6 are: element 601 is the rail to be observed for strain; element 602 is the longitudinal strain sensing cable bonded to the rail; element 603 is a representation of the markers that are incorporated into the structure of the strain sensing cable; element 604 is a representation of the marker distance from the start of the sensor cable as “seen” by the interrogator that is part of the wayside package; element 605 represents the changes in the spacing (change in distances) from marker to marker (there is none in this example); and element 606 is a representation of the local rail stress. In this case the entire rail section is under uniform thermal stress. Excessive unrelieved stress is predictive of possible rail/track buckling.

The preceding examples of rail strain and stress have assumed that the rail is at an elevated temperature and that unrelieved stress may lead to rail buckling. The reverse is also true. A rail at excessively low temperature will also experience elevated tensile stress that, if not relieved, may lead to rail fracture; that is, fracture of welds between individual rails.

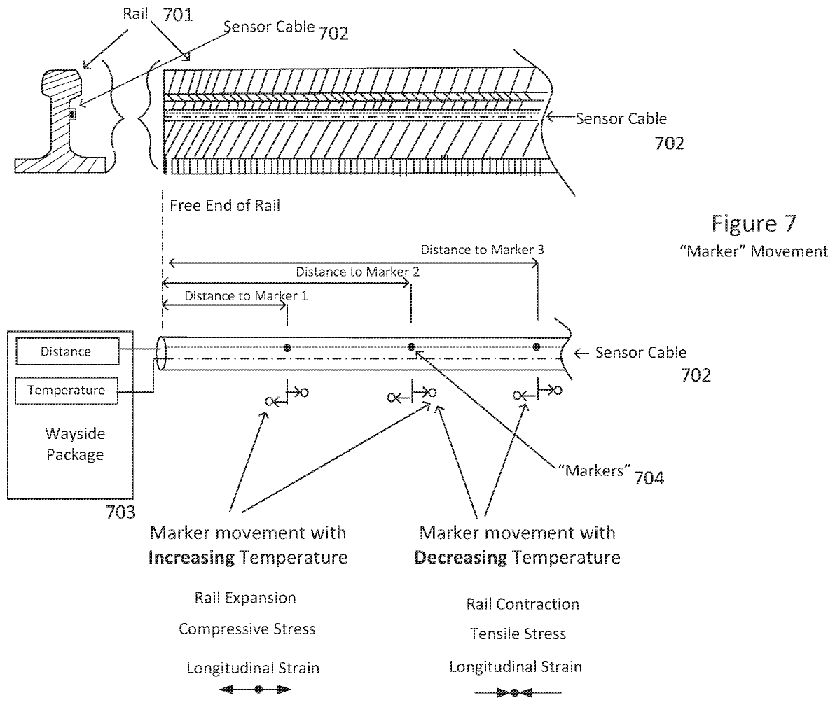

### FIG. 7

FIG. 7 shows marker movement with elevated and depressed temperatures. It shows a longitudinal strain sensor cable and the distributed linear temperature sensing cable mounted on the outside of a rail. The detail below the rail shows how the markers incorporated into the sensitive cable move in response to thermal expansion and contraction of the rail. The preferred embodiment incorporates the temperature sensor into the cable with the strain sensing fiber. The linear distributed temperature sensor can provide local rail temperatures associated with each pair of markers. An alternative embodiment may use one or more discrete rail temperature sensors. These may utilize resistance temperature detector (“RTD”), thermocouple or other suitable technology.

In FIG. 7, the OTDR device detects the motion of each marker relative to its nominal (neutral temperature) location. As the rail is unrestrained, the markers will move closer to the OTDR device as the rail is heated and further away from the OTDR device as the rail is cooled.

Elements of FIG. 7 are: element 701 is the rail; element 702 is the sensor cable that includes the strain and temperature sensing fibers; element 703 is the wayside package; and element 704 is one of the series of markers.

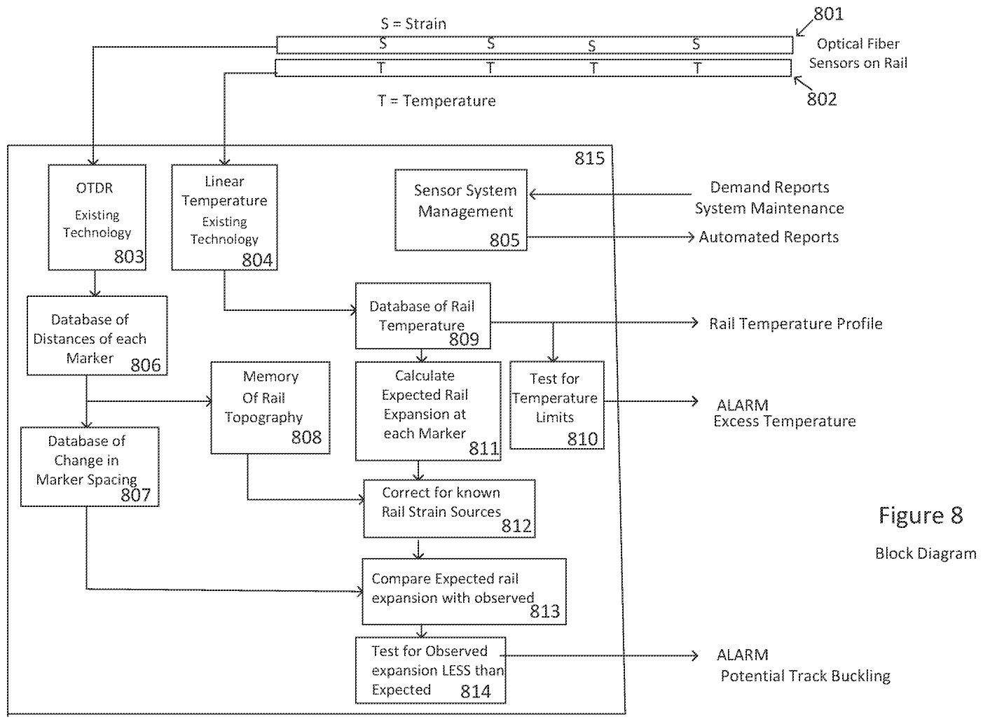

### FIG. 8

FIG. 8 illustrates the principal functions included in the invention. The functions are performed by electro-optical and data processing equipment located in the wayside package that is located in a suitable shelter near the track/rails to be monitored. The wayside package sends information to the train management operations center; including, but not limited to, the train dispatcher and the Central Train Control systems. The wayside package collects information on rail strain and rail temperature, in the form of longitudinal profiles; and provides information relating to, among other things, routine self-testing, buckling alarms, and excessive temperature.

In FIG. 8, the linear thermal detection illuminator utilizes common off-the-shelf technology, as does the OTDR. The outputs of these devices are analyzed using custom data processing applications within the environment of existing software and operating systems. An alternative embodiment may include one or more discrete temperature sensors to measure the rail temperature at spaced intervals. The alarms are suitable for being autonomously transmitted to railroad operations locations; which locations can also access wayside packages to obtain test records and rail profiles of strain and temperature. In the preferred embodiment, all of the wayside package functions will be resident in a suitable shelter that is trackside.

Elements of FIG. 8 are: element 801 is the optical fiber strain sensing cable; element 802 is the distributed linear temperature sensing cable; it being preferred that the two sensors occupy the same physical sheath. Alternate embodiments may include the linear temperature sensor in a separate cable or the use of discrete, single or multiple, temperature sensors spaced at suitable distances along the track.

Element 803 utilizes conventional OTDR technology that measures the distance to each marker; element 804 utilizes conventional distributed linear temperature sensor illuminator technology that provides local temperature and distance information; element 805 carries out a data processing function that provides overall control and timing, along with initiating regular self-tests and transmitting regular reports and alarms.

Element 806 carries out a data storage and processing function that retains the profile of the rail relating to the distances between the OTDR and each marker; element 807 records the profile of the rail relating to the spacing between markers which relates to the rail longitudinal strain; element 808 keeps a record of permanent anomalies along the rail, such as discontinuities due to rail welds, that may alter the expected strain distribution. Element 809 provides a data storage and processing function that records the temperature distribution along the length of the rail; element 810 compares the current rail temperatures to established alert and alarm values, and initiates appropriate warnings.

Element 811 converts local track temperature into expected local rail strain; element 812 provides correction of expected rail strain due to specific conditions encountered in a specific rail environment; element 813 compares the anticipated strain with the observed strain, producing a rail length profile that provides the location and intensity of normal and abnormal strain conditions. Element 814 identifies strain at specific rail locations that exceeds pre-defined limits or limits set by reference to previous experience, and is capable of autonomously initiating caution and alarm messages. Element 815 is a wayside package housed in a suitable shelter near the track/rail.

### Alternative Embodiment—Suspension Bridge

The method described herein can also be used to monitor the effectiveness of support cables used in the construction of suspension bridges. Such cables must be kept under constant tension. If one cable fails to carry its proportioned load, the other cables have to support the load. This unintended distribution of the load causes changes in the stress (force) on all of the other parts of the bridge.

Ongoing maintenance of the bridge requires constant retensioning of the cables. Each cable is composed of many individual strands of (usually) steel wire. The strands are twisted together to form a bundle. Several bundles are twisted together to form a cable. Individual strands can break, possibly due to corrosion or a material flaw. The loss of an individual wire will cause an increase in the stress (force) on the other wires. This deterioration process can be gradual.

If a longitudinal strain sensitive fiber, as described herein, is bonded to one or more wires in a bundle, changes in the distribution of strain in that bundle can be observed. The overall length of the cable does not change because it is bound at both ends as in the FIG. 6 example above of a rail bound at both ends.

If the degradation of the cable is caused by the breaking of individual strands in the bundle, there will be a change in the distribution of strain in the bundle. As a wire breaks, the adjacent wires take up the stress (force). There is a concentration of stress (force) at the locus of wire damage. This local increase in stress is reflected in a local increase of wire strain; that is, a movement of the wire.

In an alternative embodiment of this invention, a suspension cable comprises several bundles of wires. Each bundle is individually tensionable and each bundle has one or more longitudinal strain sensing fibers (as previously described) embedded in it. The distribution of strain along the length of the suspension cable can be observed by connecting a suitable fiber illuminator device as previously described. The illuminator device will reveal if the strain is uniform along the wires or if there is a concentration of strain, which concentration may indicate cable degradation. The arrangement described herein does not measure the tension on the bundle or the cable. It observes the change of strain along the length of the cable.

The remote strain sensing fiber optic technology described herein permits real time observation of the longitudinal strain distribution along the length of the suspension wires that comprise bridge support cables. Local strain changes over time may indicate local degradation or corrosion of the wire and cable.

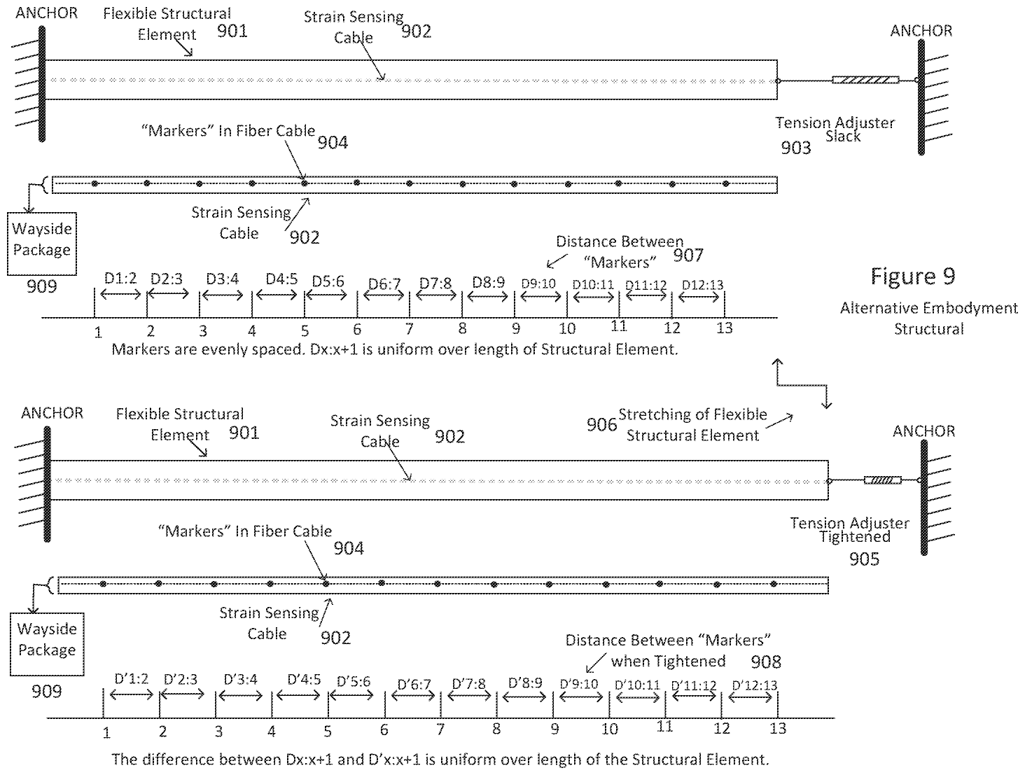

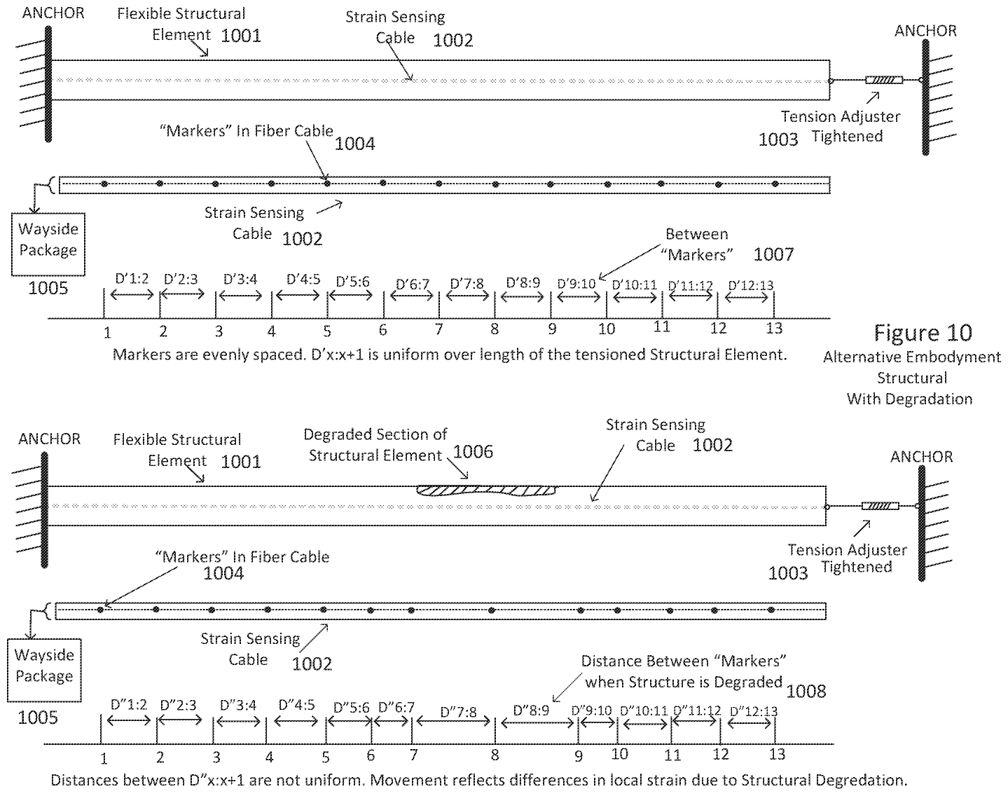

### FIGS. 9 and 10

As illustrated in FIGS. 9 and 10, the method described herein can also be used to monitor the structural integrity and effectiveness of flexible structural elements commonly used in reinforcing concrete structures and suspension bridges. The flexible structural element may be a strand of wire or similar material, a bundle of tightly bound strands, or multiple bundles forming a tendon or rope. Such wires/tendons/ropes are used to compress concrete structures such as LNG tanks, containment vessels, suspension bridge main cables, and suspender cables. In all such examples, the flexible structural element is tensioned after construction by stretching the element within its elastic limits.

Under normal conditions the strain of the element is uniform along its length because the element is of uniform configuration. When there is physical degradation to the element, the distribution of strain is altered. In most applications there is no way to directly observe the degraded portion of the element or to observe the location and extent of the degradation. The method described here provides a means to make such observations.

### FIG. 9

FIG. 9 illustrates the way in which a flexible structural element responds to the application of stress. In this case, stress is caused by a ‘tension adjusting’ device. The resulting distribution of strain along the length of the element can be observed using the previously described markers incorporated in an attached fiber optic cable. When the element is slack (that is, unstressed), the distances between markers are uniform as dictated by the process that incorporated the markers in the fiber. When the element is placed under stress by the tension adjusting device, the element stretches. The corresponding stretching of the optical fiber causes the markers to spread apart uniformly along the length of the element.

The degree of extension of each inter-marker distance is controlled by the uniform cross-section of the element. If there is variation in the element cross-section along its length, there will be variation in the local stress, reflecting the local cross-section. The stress vs. length along the element profile of the marker spacing is directly related to the profile of the strain in the element.

In FIG. 9, element 901 is the flexible structural element that is under observation; element 902 is the strain sensing fiber optic cable that is bonded to the structural element using an appropriate methodology; element 903 is the tension adjusting device that is used to apply stress to the element; element 904 is the markers that are discontinuities applied to the cable during manufacturing; element 905 is the tension adjusting device that has applied stress to the structural element and thereby caused the structural element to stretch and the markers to move apart; element 906 represents the extent to which the structural element has stretched due to the tension adjusting device; element 907 represents the uniform spacing between the markers with no stress in the structural element; element 908 represents the uniform but increased, spacing between the markers when the tension adjusting device has applied stress to the structural element; and element 909 represents the wayside package that includes the needed electro-optical and data processing functions to interrogate the strain sensing cable.

### FIG. 10

FIG. 10 illustrates the way the flexible structural element responds to local structural integrity degradation due to such things as cracking, corrosion or other damage. In this figure the structural element is shown under strain from the tightened adjusting device. The marker spacing is uniform as dictated by the optical fiber manufacturing process and the uniformity of the structural element. In the lower detail, the flexible structural element has suffered degradation that altered its structural integrity.

The degradation (for example, a breaking of some strands of a multi-strand cable) locally reduces the element cross-section and increases the local strain. This is reflected as an alteration in the marker locations. The marker spacing increases in response to increased local strain. The observed change in marker spacing can be used to identify the existence and location of the degraded portion of the structural element.

In FIG. 10, element 1001 is the flexible structural element that is under observation; element 1002 is the strain sensing cable that is bonded to the structural element using an appropriate methodology; element 1003 is the tension adjusting device that is applying stress to the structural element; element 1004 is the markers that are the discontinuities that were applied to the cable during the manufacturing process; element 1005 is the wayside package that contains the electro-optical and data processing functions needed to interrogate the strain sensing cable; element 1006 represents the region of the structural element that has been structurally degraded; element 1007 represents the even spacing between the markers in the absence of any alteration to the uniform structure of the structural element; and element 1008 represents the non-uniform spacing of the markers that reflects the alteration of the structural integrity of the structural element.

This arrangement for observing the distribution of strain in a cable can be applied to several other structural environments. These include cable stay bridges; cable wrapped concrete tanks such as liquefied natural gas tanks; and concrete containment buildings such as nuclear reactor buildings.

Another embodiment of the longitudinal strain sensing optical fiber technology described herein, is the design and maintenance of naval vessels. The hull of the vessel, be it a submarine or a surface ship, is subject to hydraulic forces acting on the steel structure. The structural integrity of the hull relies on the resolution of all forces in a way that avoids any unexpected concentration of force (stress).

The hull of a submarine can withstand the compressive forces of the depth if those forces are uniformly distributed. Buckling at any location in the hull can result in the implosion of the vessel when it is under water. This technology permits the monitoring of hull stress as exhibited in changes in hull strain. The technology permits continuous monitoring of the entire pressure hull.

Hull failure can be preceded by an unexpected concentration of stress in a particular location. This concentration of stress will manifest itself as a concentration of strain, which can be detected as previously described. This technology can detect the strain profile over the entire submarine pressure hull. A region of unexpectedly low strain can be a warning of impending hull implosion.

The fiber sensor cable can be bonded to the pressure hull of the submarine prior to the application of the acoustic absorption coatings. This technology can provide the exact location of structural elements that exhibit higher than expected strain and are sometimes heard groaning as they flex under hydraulic stress.

Another embodiment of the longitudinal strain sensing optical fiber technology described herein is the design of surface craft. The technology permits the Navy to monitor the structural integrity of the hull plates and observe any unexpected concentrations of stress by monitoring consequent strain. This continuous observation of the complete strain distribution of the hull can provide a warning of unexpected structural degradation prior to plate buckling. The sensor fibers can be bonded to the ship's outer hull prior to the application of anti-radar and anti-sonar coatings. This technology can provide a warning of hull design problems before permanent damage Occurs. Applying the optical fiber sensors to the outside of the hull avoids the limitations of getting around the bulkheads welded to the inside of the hull.

The aforementioned arrangement and method for monitoring strain in a submarine hull is equally applicable to industrial pressure tanks or containers, such as vacuum chambers and tanks containing fluid under pressure.

I claim:

1. Apparatus for monitoring longitudinal strain in a railroad rail and determining a location along the rail where there is a significant risk of buckling at elevated temperature, comprising:
a length of fiber optic cable secured to a side of the rail, said cable including a series of longitudinally spaced optical backscatter creating discontinuities;
optical signal transmitting, receiving and data processing means operatively associated with said cable for determining changes in the cable strain between said discontinuities;
threshold setting means for setting a rail temperature dependent threshold strain change parameter corresponding to a minimum acceptable level of longitudinal rail strain change between said discontinuities;
warning means coupled to said optical signal transmitting, receiving and data processing means and said threshold setting means for generating a buckling risk warning signal when the cable strain change at a buckling risk location adjacent one or more of said discontinuities falls below the parameter set by said threshold setting means,
whereby said warning signal is generated when an unacceptably low amount of strain change occurs; and
buckling risk location means operatively associated with said warning means for determining and displaying said buckling risk location.

2. The apparatus according to claim 1, wherein said rail comprises a series of rail sections with ends that have been welded together.

3. The apparatus according to claim 2, wherein said cable includes portions between said rail sections without said discontinuities.

4. The apparatus according to claim 1 or 2, wherein said cable discontinuities cause reflected backscatter pulses in a pulsed optical signal transmitted through said cable, and said signal transmitting, receiving and data processing means includes means for determining the optical signal transit time between each of said backscatter pulses and said optical signal transmitting, receiving and data processing means.

5. The apparatus according to claim 4, wherein said buckling risk location means comprises means for measuring the transit time between (i) said signal transmitting, receiving and data processing means, and (ii) said buckling risk location, namely the location at which the cable strain change falls below said parameter.

6. The apparatus according to claim 5, wherein said rail has temperature sensitive signal generating transducers spaced at predetermined intervals along the rail, and said cable is optically coupled to said transducers for transmitting transducer information signals indicative of the temperature and location of each of said transducers, without significantly interfering with the signals due to the presence of said backscatter creating discontinuities.

7. The apparatus according to claim 4, wherein said buckling risk location means comprises a monitoring station and means for determining the transit time between the buckling risk location and the monitoring station.

8. Apparatus for monitoring longitudinal strain in a railroad rail and determining a location along the rail where there is a significant risk of buckling, comprising:
a length of fiber optic cable secured to a side of the rail, said cable including a series of longitudinally spaced optical backscatter creating discontinuities;
signal transmitting and receiving means operatively associated with said cable for determining changes in the distances between the discontinuities;
threshold setting means for setting a rail temperature dependent threshold distance change between discontinuities, which threshold distance change corresponds to a minimum acceptable level of change in longitudinal rail strain;
warning means coupled to said signal transmitting and receiving means and said threshold setting means for generating a buckling risk warning signal when the distance change between the discontinuities at a buckling risk location along the rail falls below the minimum threshold distance change set by said threshold setting means; and
buckling risk location determining means operatively associated with said warning means for determining and displaying said buckling risk location, by determining the transit time of an optical signal between the buckling risk location and the buckling risk location determining means.

9. The apparatus according to claim 4, wherein each discontinuity reduces the amplitude of the transmitted optical signal by a relatively small amount.

10. The apparatus according to claim 4, wherein the coefficient of thermal expansion of said cable is substantially equal to the coefficient of thermal expansion of said rail.

11. The apparatus according to claim 4, wherein said discontinuities are equally spaced apart.

12. The apparatus according to claim 11, wherein the distance between adjacent discontinuities is sufficiently great to be discernable, and sufficiently small to enable location of the section of rail where there is buckling risk.

13. The apparatus according to claim 4, wherein said threshold setting means sets said parameter based on a change from the distance between adjacent discontinuities when the rail is at a high risk temperature where buckling risk increases substantially.

14. The apparatus according to claim 13, wherein said threshold setting means includes (i) an absolute temperature threshold derived from track design calculations, and (ii) means for calculating a temperature indicative of the existence of excessive stress conditions.

15. The apparatus according to claim 11, wherein change in the distance between adjacent discontinuities is monitored more frequently as the rail temperature increases.

16. Apparatus for monitoring longitudinal strain in a railroad rail and determining a location along the rail where there is a significant risk of rail fracture due to contraction stress at low temperature, comprising:
a length of fiber optic cable secured to a side of the rail, said cable including a series of longitudinally spaced optical backscatter creating discontinuities;
optical signal transmitting, receiving and data processing means operatively associated with said cable for determining decreases in the cable strain between said discontinuities;
threshold setting means for setting a rail temperature dependent threshold strain change parameter corresponding to a minimum acceptable level of low temperature longitudinal rail strain change between said discontinuities;
warning means coupled to said optical signal transmitting, receiving and data processing means and said threshold setting means for generating a fracture risk warning signal when the cable strain change at a low temperature fracture risk location adjacent one or more of said discontinuities falls below the parameter set by said threshold setting means,
whereby said warning signal is generated when an unacceptably low amount of strain change occurs; and
fracture risk location means operatively associated with said warning means for determining and displaying said fracture risk location.

17. The apparatus according to claim 16, wherein said rail comprises a series of rail sections with ends that have been welded together, there being a risk of fracture between said sections at low temperature.

18. The apparatus according to claim 17, wherein said cable includes portions between said rail sections without said discontinuities.

19. The apparatus according to claim 16 or 17, wherein said cable discontinuities cause momentary backscatter reflections in the nature of pulses in an optical signal transmitted through said cable, which pulses are reflected back toward said light source; and said signal transmitting, receiving and data processing means includes means for determining the optical signal round trip transit time between each of said pulses and said optical signal transmitting, receiving and data processing means.

20. The apparatus according to claim 19, wherein said fracture risk location means comprises means for measuring the round trip transit time between (i) said signal transmitting, receiving and data processing means, and (ii) said fracture risk location, namely the location at which the cable strain change falls below said parameter.

21. The apparatus according to claim 20, wherein said rail has temperature sensitive signal generating transducers spaced at predetermined intervals along the rail, and said cable is optically coupled to said transducers for transmitting transducer information signals indicative of the temperature and location of each of said transducers, without significantly interfering with the signals due to the presence of said backscatter creating discontinuities.

22. The apparatus according to claim 20, wherein said fracture risk location means comprises a monitoring station and means for determining the transit time between the buckling risk location and the monitoring station.

23. A process for monitoring longitudinal strain in a railroad rail and determining a location along the rail where there is a significant risk of buckling, comprising the steps of:
affixing a length of fiber optic cable to a side of the rail, said cable including a series of longitudinally spaced optical backscatter creating discontinuities;
transmitting an optical signal through said cable from a light source, said discontinuities causing backscatter of said signal;
receiving and data processing the backscatter containing optical signal to determine changes in the cable strain between said discontinuities;
setting a rail temperature dependent threshold strain change parameter corresponding to a minimum acceptable level of longitudinal rail strain change between said discontinuities;
generating a buckling risk warning signal when the cable strain change at a buckling risk location adjacent one or more of said discontinuities falls below said parameter; and
determining the buckling risk location by measuring the optical signal transit time between a known location and the location at which the cable strain change falls below said parameter.

24. The process according to claim 23, wherein said receiving and data processing means receives a signal reflected back toward the light source.

25. The process according to claim 24, wherein said threshold is set as a function of (i) an absolute temperature threshold derived from track design calculations, and (ii) a temperature indicating excessive stress conditions exist.

26. The process according to claim 24 or 25, wherein changes in the cable strain between two discontinuities are determined by measuring the travel time between emanation of light from the light source and receipt of backscatter light reflected from said two discontinuities.

27. Apparatus for monitoring longitudinal strain in a multi-strand support cable under tension and determining when there is a significant likelihood that at least one cable strand has broken, comprising:
a length of fiber optic cable secured to the support cable, said fiber optic cable including two or more longitudinally spaced optical backscatter creating discontinuities;
optical signal transmitting, receiving and data processing means, including a light source, operatively associated with said fiber optic cable for determining changes in the cable strain between said light source and at least one of said discontinuities by measuring the round trip transit time between said signal transmitting, receiving and data processing means and said at least one discontinuity;
threshold setting means for setting a threshold strain change parameter corresponding to a maximum acceptable level of longitudinal support cable strain change between said signal transmitting, receiving and data processing means and said at least one discontinuity; and
warning means coupled to said optical signal transmitting, receiving and data processing means and said threshold setting means for generating a support cable strand breakage warning signal when the cable strain change between said signal transmitting, receiving and data processing means and said at least one discontinuity exceeds the parameter set by said threshold setting means,
whereby said warning signal is generated when there is likely to be a breakage of said strand.

28. Apparatus for monitoring longitudinal strain in an enclosed vessel under internal or external pressure, said vessel having a surrounding hull or casing, and determining when there is a significant likelihood of collapse of said hull or casing due to such pressure, comprising:
a length of fiber optic cable secured to the hull or casing, said fiber optic cable including two or more longitudinally spaced optical backscatter creating discontinuities;
optical signal transmitting, receiving and data processing means, including a light source, operatively associated with said fiber optic cable for determining changes in the cable strain between said light source and at least one of said discontinuities by measuring the transit time between said signal transmitting, receiving and data processing means and said at least one discontinuity;
threshold setting means for setting a threshold strain change parameter corresponding to a maximum acceptable level of hull or casing strain change between said signal transmitting, receiving and data processing means and said at least one discontinuity; and
warning means coupled to said optical signal transmitting, receiving and data processing means and said threshold setting means for generating a hull or casing warning signal when the cable strain change between said signal transmitting, receiving and data processing means and said at least one discontinuity exceeds the parameter set by said threshold setting means,
whereby said warning signal is generated when there is likely to be a collapse of said hull or casing.
